(19) United States
(12) Patent Application Publication
(10) Pub. No.: US 2019/0314706 A1
(43) Pub. Date: Oct. 17, 2019

(54) MODULAR PROTECTOR AND SCORING SYSTEM

(71) Applicant: Jin Song, Freemont, CA (US)

(72) Inventor: Jin Song, Freemont, CA (US)

(21) Appl. No.: 16/245,996

(22) Filed: Jan. 11, 2019

Related U.S. Application Data
(60) Provisional application No. 62/616,025, filed on Jan. 11, 2018.

(51) Int. Cl. A63B 71/06; G01L 5/00; A63B 71/12; A42B 3/30; A41D 13/00; A41D 13/05

(52) U.S. Cl. CPC A63B 71/0669; A41D 2600/10; A63B 71/12; A63B 71/0622; A42B 3/30; A41D 13/0002; A41D 13/0015; A41D 13/0518; A63B 2209/10; A63B 2209/08; A63B 2071/0655; A63B 2071/0625; A63B 2220/53; A63B 2225/50; A63B 2220/836; A63B 2244/10; G01L 5/0052

(57) ABSTRACT

A scoring system comprising at least one chest protector comprising at least one sensor and at least one transmitter, at least one receiver, and at least one exterior cover designed to enclose the chest protector.

### BACKGROUND OF THE INVENTION

In Olympic TaeKwondo, high technology electronic scoring system is used to automatically score valid techniques delivered by the competitors. The electronic Point Scoring System (hereafter “PSS”) includes electronic body protector, electronic head protector, electronic foot gear, radio communication hardware/software, sensor processing hardware/software and graphic user interface (hereafter “GUI”). The function of each components of the system is fully documented in various forms of user manuals and previous patents (both granted and pending).

### SUMMARY OF THE INVENTION

In one embodiment, a scoring system comprising at least one chest protector comprising at least one sensor and at least one transmitter, at least one receiver, and at least one exterior cover designed to enclose the chest protector.

In another embodiment, wherein the sensor is selected from a group consisting essentially of impact sensor, proximity sensor, magnetic proximity sensor, metal detector proximity sensor and combinations thereof.

In a further embodiment, wherein the proximity sensor functions to distinguish incidental contact from deliberate contact that is a valid point.

In yet another embodiment, wherein the cover comprises a means for securing the cover to the chest protector.

In yet a further embodiment, wherein the means for securing the cover to the chest protector is selected from a group comprising elastic, zippers, magnets, buttons, snaps, hooks and loops, straps, Velcro, ______ and combinations thereof.

In still yet a further embodiment wherein the cover comprises artwork.

In another embodiment, wherein the cover comprises graphics.

In a further embodiment, wherein the cover is removable and washable.

In still yet another embodiment, further comprising at least one helmet and at least one helmet skin.

In a further embodiment, wherein said means for securing said skin to said helmet protector is selected from a group comprising elastic, zippers, magnets, buttons, snaps, hooks and loops, straps, Velcro, and combinations thereof.

In still yet a further embodiment wherein the skin comprises artwork.

In another embodiment, wherein the skin comprises graphics.

In a further embodiment, wherein the skin is removable and washable.

In yet another embodiment, wherein the receiver can be attached to a computer and display device.

In yet a further embodiment, wherein the receiver is attached to the helmet and the system is a stand alone device.

In still yet another embodiment, wherein said helmet as an indicator device, the device is capable of providing a signal from the helmet to indicate when a valid point is cored.

In still yet a further embodiment, wherein the signal from a group comprising an audible signal, a visual signal, a tactile signal, or a combination thereof.

In another embodiment, where the transmitter is removable from the chest protector.

In a further embodiment, where the sensor is removable from the chest protector.

In yet another embodiment, where the receiver is removable from the helmet.

In yet a further embodiment, where at least one foot gear is designed to make impact with the chest protector thereby activating the sensor and the impact is then read by the transmitter and sent to the receiver to show that a body shot was scored by a kick.

In still yet another embodiment that further comprises at least one pair of gloves designed to make impact with the chest protector thereby activating the sensor and the impact is then read by the transmitter and sent to the receiver to show that a body shot was scored by a punch.

In still yet a further embodiment a modular scoring system comprising an insert forming an internal component of a chest protector, the insert comprising at least one sensor and at least one transmitter, a removable shell forming an exterior component of the chest protector, and at least one receiver.

In another embodiment, wherein the shell is customizable selected from a group comprising of artwork, graphics, designs, logos, and combinations thereof.

In a further embodiment, wherein the sensor is selected from a group consisting essentially of impact sensor, proximity sensor, magnetic proximity sensor, metal detector proximity sensor and combinations thereof.

In yet another embodiment, wherein the removable shell is washable.

In an even further embodiment protective sports equipment comprising a chest protector; and a removable shell forming an exterior component for the chest protector.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 and FIG. 2 show chest protectors with the exterior covers on them;

FIG. 3 shows the chest protector without the exterior cover and also shows the sensor;

FIG. 4 shows the an up close view of the sensor and chest protect without the cover; and

FIG. 5 shows the cover without the chest protector and sensor inside it.

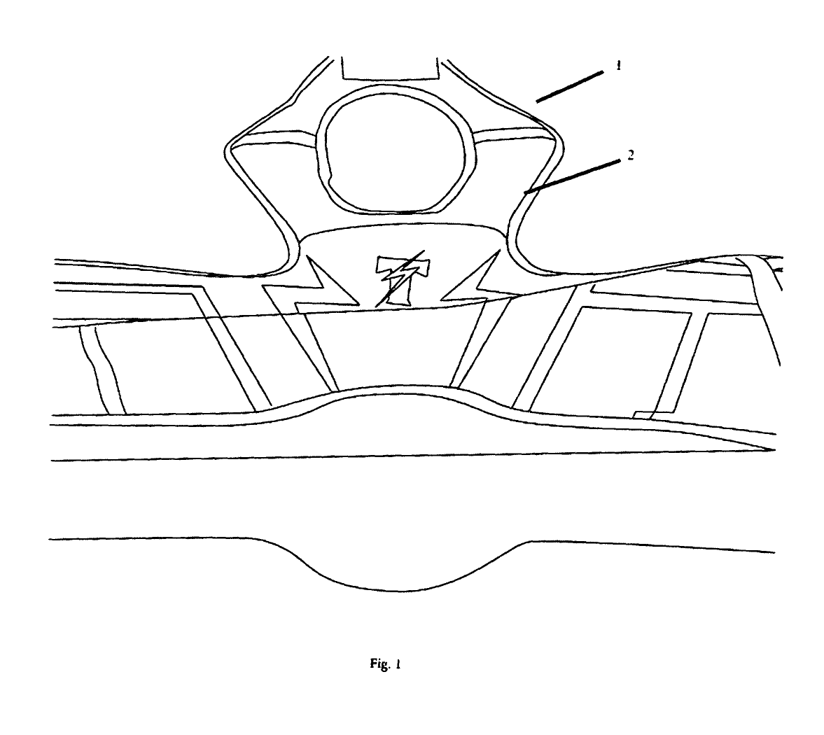

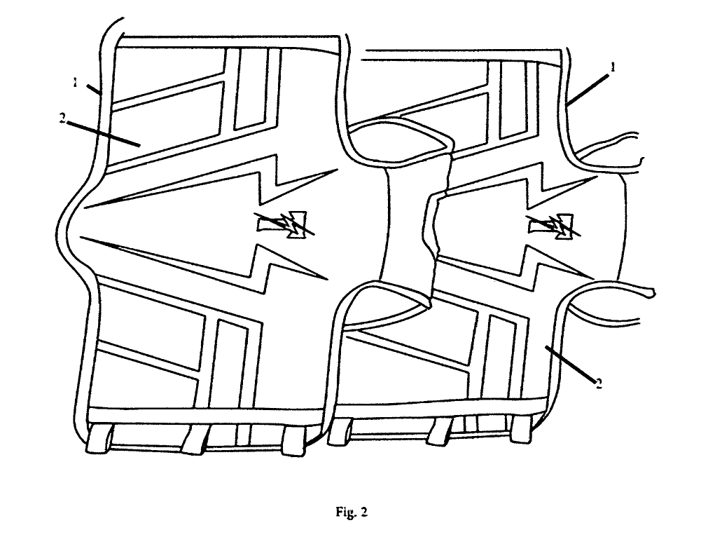

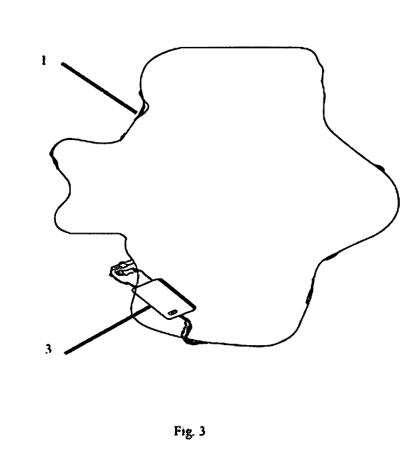

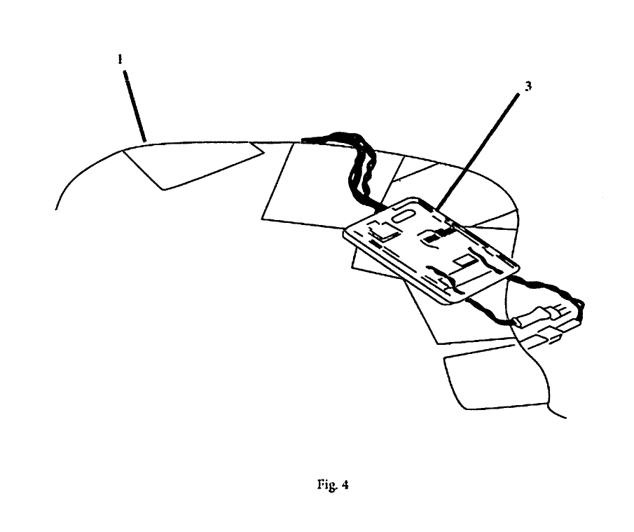

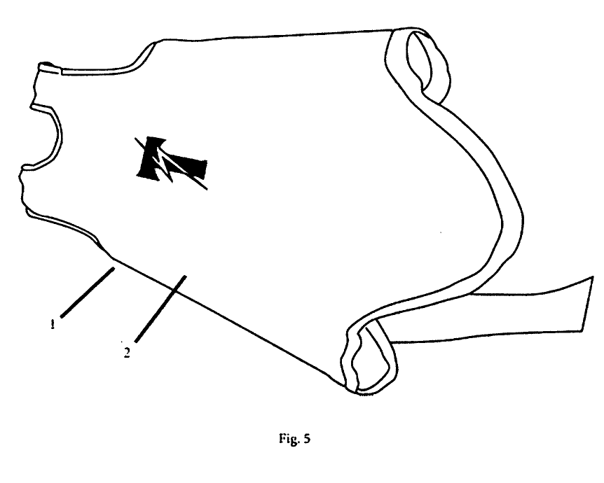

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

In the current invention, the radio communication hardware, transmitters, and/or receivers are modular and removable from the chest protectors. The advantage of this is the ability to manufacture and service these items separately from the body protector (chest protector) and/or head protector (helmet), saving cost in manufacturing and maintenance during the life of the products. This is key because the sensors are made to operate in pairs. Before in the event that one of the two sensors no longer functions, that would mean that in order to replace them, both sets of body protectors (chest protectors) and both sets of head protectors (helmets) would have to be replaced. In the instant invention, components can be swapped out as need be for repair or maintenance.

Among the protectors, the body protector (chest protector) is the most expensive and physically battered component due to the nature of the sport. The body protector (chest protector) is built with two components: the outer shell and the inner inserts. The main functions of the outer shell is to protect both the athletic participant and the insert that has the sensor (and data acquisition electronics) embedded in it. In addition, the shell is designed to indicate manufacturer identification and the athletic participant's identification in other words, red color theme for red player, and blue color theme for the blue player).

In competition, one player must wear red, while the other wears blue. Currently the insert is permanently enclosed by the shell and servicable. A malfunction in either color renders the matching opposing color unusable. Furthermore during the life of the body protector (chest protector), the wear and tear of the outer shell makes it unusable even though the insert itself may still be functioning properly.

The new design concept modularizes the body protector where the insert is removable from the shell. The insert is completely self contained, while the shell has an access feature that allows the insert to be removed. The modularization allows the shell to be manufactured, and maintained separately from the insert. Worn out shell can be serviced and or replaced while retaining the insert. Furthermore, the graphics on the shell can be customized to reflect manufacturer, organization, or special event commemoration. Since the shell is remove-able, the customized shell can be used temporarily and replaced as needed. During the competition, the inserts can be inserted into any color theme shell to pair up with the opposite color theme as necessary.

This concept is novel in the Olympic taekwondo. The modular body protector allows significant cost benefits to manufacturing and maintenance, while providing practical solution to the competition logistics problems as well as user appeal, and branding opportunity for manufacturers.

The scoring system of this invention comprising at least one chest protector comprising at least one sensor and at least one transmitter, at least one receiver, and at least one exterior cover designed to enclose the chest protector. The sensor is selected from a group consisting essentially of impact sensor, proximity sensor, magnetic proximity sensor, metal detector proximity sensor and combinations thereof. The proximity sensor functions to distinguish incidental contact from deliberate contact that is a valid point.

The cover comprises a means for securing the cover to the chest protector. The means for securing the cover to the chest protector is selected from a group comprising zippers, magnets, buttons, snaps, hooks and loops, straps, Velcro, ______ and combinations thereof.

The cover comprises either artwork or comprises graphics and is removable and washable.

The present invention comprising at least one helmet and at least one helmet skin. The means for securing said cover to said chest protector is selected from a group comprising elastic, zippers, magnets, buttons, snaps, hooks and loops, straps, Velcro, ______ and combinations thereof. The helmet the skin comprises artwork or graphics and is removable and washable.

The receiver can be attached to a computer and display device or the receiver is attached to the helmet and the system is a stand alone device.

The helmet can also have as an indicator device, the device is capable of providing a signal from the helmet to indicate when a valid point is scored. The signal from a group comprising an audible signal, a visual signal, a tactile signal, or a combination thereof.

The transmitter and the sensor are removable from the chest protector. The sensor is removable from the chest protector. The receiver and the indicator are removable from the helmet.

The system can have foot gear that is designed to make impact with the chest protector thereby activating the sensor and the impact is then read by the transmitter and sent to the receiver to show that a body shot was scored by a kick.

The system can have gloves designed to make impact with the chest protector thereby activating the sensor and the impact is then read by the transmitter and sent to the receiver to show that a body shot was scored by a punch.

The system having a modular scoring system comprising an insert forming an internal component of a chest protector, the insert comprising at least one sensor and at least one transmitter, a removable shell forming an exterior component of the chest protector, and at least one receiver.

The shell is customizable selected from a group comprising of artwork, graphics, designs, logos, and combinations thereof.

The sensor is selected from a group consisting essentially of impact sensor, proximity sensor, magnetic proximity sensor, metal detector proximity sensor and combinations thereof. The removable shell is washable.

What is claimed is:

1. A scoring system comprising:
at least one chest protector comprising at least one sensor and at least one transmitter;
at least one receiver; and
at least one exterior cover designed to enclose said chest protector.

2. The system of claim 1 wherein said sensor is selected from a group consisting essentially of impact sensor, proximity sensor, magnetic proximity sensor, metal detector proximity sensor and combinations thereof.

3. The system of claim 2 wherein said proximity sensor functions to distinguish incidental contact from deliberate contact that is a valid point.

4. The system of claim 1 wherein said cover comprises a means for securing said cover to said chest protector.

5. The system of claim 4 wherein said means for securing said cover to said chest protector is selected from a group comprising zippers, magnets, buttons, snaps, hooks and loops, straps, Velcro, and combinations thereof.

6. The system of claim 1 wherein said cover comprises artwork.

7. The system of claim 1 wherein said cover comprises graphics.

8. The system of claim 1 wherein said cover is removable and washable.

9. The system of claim 1 further comprising at least one helmet and at least one helmet skin.

10. The system of claim 9 wherein said means for securing said skin to said helmet is selected from a group comprising elastic, zippers, magnets, buttons, snaps, hooks and loops, straps, Velcro, and combinations thereof.

11. The system of claim 9 wherein said skin comprises artwork.

12. The system of claim 9 wherein said skin comprises graphics.

13. The system of claim 9 wherein said skin is removable and washable.

14. The system of claim 1 wherein said receiver can be attached to a computer and display device.

15. The system of claim 6 wherein said receiver is attached to said helmet and said system is a stand alone device.

16. The system of claim 11 wherein said helmet as an indicator device, said device is capable of providing a signal from the helmet to indicate when a valid point is cored.

17. The system of claim 12 wherein said signal from a group comprising an audible signal, a visual signal, a tactile signal, or a combination thereof.

18. The system of claim 1 where the transmitter is removable from said chest protector.

19. The system of claim 1 where the sensor is removable from said chest protector.

20. The system of claim 1 where the receiver is removable from said helmet.

21. The system of claim 1 further comprising at least one foot gear designed to make impact with said chest protector thereby activating said sensor and the impact is then read by said transmitter and sent to said receiver to show that a body shot was scored by a kick.

22. The system of claim 1 further comprises at least one pair of gloves designed to make impact with said chest protector thereby activating said sensor and the impact is then read by said transmitter and sent to said receiver to show that a body shot was scored by a punch.

23. A protective sports equipment comprising:
a chest protector; and
a removable shell forming an exterior component of said chest protector.

24. The system of claim 14 wherein said shell is customizable selected from a group comprising of artwork, graphics, designs, logos, and combinations thereof.

25. The system of claim 14 wherein said sensor is selected from a group consisting essentially of impact sensor, proximity sensor, magnetic proximity sensor, metal detector proximity sensor and combinations thereof.

26. The system of claim 14 wherein said removable shell is washable.

27. A modular scoring system comprising:
an insert forming an internal component of a chest protector, said insert comprising at least one sensor and at least one transmitter;
a removable shell forming an exterior component of said chest protector; and
at least one receiver.
